(19) United States
(12) Patent Application Publication
(10) Pub. No.: US 2009/0307009 A1
(43) Pub. Date: Dec. 10, 2009

(54) WIDGET ASSOCIATED WITH NETWORKING PLATFORM

(76) Inventors: Laura Nuhaan, Portola Valley, CA (US); Inger Rarick, Portola Valley, CA (US)

Correspondence Address: PERKINS COIE LLP, P.O. BOX 1208, SEATTLE, WA, 98111-1208, US

(21) Appl. No.: 12/136,748

(22) Filed: Jun. 10, 2008

(51) Int. Cl. G06Q 50/00; G06Q 99/00; G01C 21/00

(52) U.S. Cl. 705/2; 705/1; 701/300

(57) ABSTRACT

Systems and methods for enabling caregivers to communicate with care-receivers and share information and data are described. The care-receiver may use a family-oriented networking platform as it provides an easy and intuitive way to stay in touch with their families and healthcare professionals. The objective of the present invention is to allow caregivers to use their preferred means of digital communication to communicate with the care-receivers

### BACKGROUND

The following examples of the related art and limitations related therewith are intended to be illustrative and not exclusive. Other limitations of the related art will become apparent upon a reading of the specification and a study of the drawings.

As life expectancy increases globally, the elderly population around the world is also sharply rising. For example, in 2005 in the United States the population age sixty-five and over was approximately 36 million which is expected to grow to 86 million in 2050. The elderly may live alone or with another aged partner. Oftentimes, the children of the elderly and other family members of the elderly live in a different residence, sometimes in another state, or another country. The geographic separation of family members has increased the difficulty for providing the elderly with needed care. For example, many elderly individuals may experience mobility difficulties and can easily slip and fall. Further, due to deterioration of memory, the elderly tend to easily forget to take their medicine, or forget the instructions for taking their medicine, having detrimental and sometimes fatal effects.

In addition, most of the aging population is not accustomed to operating electronics or devices to enable frequent communication and interaction with children or other family members living remotely via email or the like. In some situations, the older generation may not be used to using telephonic devices such as the fax machine for communication. Thus, maintaining frequent communication with elder parents that live at a distance remains difficult.

Furthermore, the children of elderly citizens typically have a career and young children of their own to watch over. Even if the aging population had other nearby family members, it would be difficult in practice for the family member to provide adequate care for the aging parent on a regular basis. Additionally, the cost of assisted living for senior citizens is high and the elderly tend to prefer to live independently in their own homes.

### SUMMARY

The following examples and aspects thereof are described and illustrated in conjunction with systems, tools, and methods that are meant to be exemplary and illustrative, not limiting in scope. In various examples, one or more of the above-described problems have been reduced or eliminated, while other examples are directed to other improvements.

Systems and methods for facilitating interactions between care-receivers and caregivers are described. A care-receiver may be any individual that may have limited computer abilities. The care-receiver may need special medical attention. For example, a care-receiver may be, but is not limited to, an elderly person, a person with a disability, or a non-computer literate individual, or any combination thereof. A caregiver may be a family member or a healthcare provider of the care-receiver.

The current invention enables caregivers to communicate with care-receivers and share information and data. The care-receiver may use the family-oriented networking platform as it provides an easy and intuitive way to stay in touch with their families and healthcare professionals. The objective of the present invention is to allow caregivers to use their preferred means of digital communication to communicate with the care-receivers. The preferred means of digital communication may be through the use of a web-application such as, but not limited to, Facebook, Twitter, iTunes, or Instant Messenger. It is possible with the current invention to send information or data from such web-applications to the family-oriented networking platform.

In one embodiment, the caregiver may choose photos from a Facebook photo album and send said photos to the care-receiver. These photos will then appear on the care-receiver's email inbox of the family-oriented networking platform or in a dedicated place on the family-oriented networking platform, wherein the care-receiver does not need to open attachments to view said photos.

In another embodiment, the caregiver may type a message in an Instant Messenger and send this message to the care-receiver, wherein the message will be converted into an email that will appear in the care-receiver's email inbox of the family-oriented networking platform. The care-receiver may send a message back to the caregiver, and said message will be translated by the widget to show up in the Instant Messenger of the caregiver.

In a further embodiment, a caregiver may send reminders or calendar events to a care-receiver that will show up in the care-receiver's calendar on the family-oriented networking platform or may be converted to an email and appear in the caregiver's email inbox on the family-oriented networking platform. In one embodiment, the reminders or calendar events may be sent to a handheld device to inform the care-receiver of any appointments or medication to take. Reminders and calendar events can also be sent to the handheld device as text to speech, whereby the care-receiver hears the reminders and calendar events as voice messages. The care-receiver can confirm receipt of reminders or calendar events, and a confirmation will then be sent to the family-oriented networking platform. The handheld device may further include sensors that measure health parameters to assess whether the care-receiver may need help. These health parameters may include pulse, heat, motion or any combination thereof. When these parameters show that the care-receiver requires help, the handheld device may alert emergency services by sending a signal to said emergency services. This signal may include information relating to the location of the care-receiver, if the handheld device includes sensors that permit spatial localization. The handheld device may also be used to provide directions to the care-receiver to a predetermined address.

The present disclosure includes methods and systems which perform these methods, including processing systems which perform these methods, and computer readable media which when executed on processing systems cause the systems to perform these methods. Other features of the present disclosure will be apparent from the accompanying drawings and from the detailed description which follows.

### BRIEF DESCRIPTION OF THE DRAWINGS

FIG. 1 depicts an example of a method for providing a widget to facilitate interactions between one or more caregivers and one or more care-receivers.

FIG. 2 depicts an example of a flowchart of a method for a web-application to communicate with a family-oriented networking platform.

FIG. 3 depicts an example of a method for facilitating interactions between a caregiver and a care-receiver.

FIG. 4 depicts an example of a system for monitoring health parameters of a care-receiver and alerting a predetermined recipient in case of emergency.

FIG. 5 illustrates an example screenshot of a user interface of a widget, according to one embodiment.

FIG. 6 depicts an example of a device for providing interaction of a caregiver on a web-application with care-receiver on a family-oriented networking platform

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the invention. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include systems and methods of a widget allowing a user of a web-application to interact with a user of a family-oriented networking platform. Embodiments of the present disclosure further relate to facilitating web-based interactions between care-receivers and caregivers. A care-receiver may be any person with limited computer ability, and may include, in a non-limiting example, an elderly or a disabled person.

A family-oriented networking platform provides an intuitive user interface that enables users with limited computer abilities to interact with other individuals. The family-oriented networking platform enables the user with limited computer ability to stay in touch and share information with family members and other individuals.

In one embodiment, a widget is provided for a user of a web-application to communicate with a user of a family-oriented networking platform. A web-application may be a website or application used to communicate with other individuals, a digital media player, a digital photo organizer, or any application capable of accessing the internet. Non-limiting examples of such web-applications are FACEBOOK, AIM, MSN, GTALK, ITUNES, IPHOTO, and TWITTER. Alternatively, a web-application may be a plug-in or pre-installed application on any device capable of communicating with the family-oriented networking platform.

The widget may be installed by a user of the web-application on said web-application. Said user of the web-application may elect to send data to one or more users of the family-oriented networking platform. Said data will be translated by the widget to be presented on the family-oriented networking platform's user interface of the one or more care-receivers.

In one embodiment, the caregiver may send photos to a care-receiver through the use of a widget on the web-application. The caregiver can select the photos to be sent and select one or more care-receivers which will be the recipients of said photos. In one embodiment, the widget may convert the photos, including any associated textual data, into an email that will appear in the inbox of the care-receiver on the family-oriented networking platform. Alternatively, said photos and any associated textual data may appear in a specific location on the user interface of the family-oriented networking platform.

In one embodiment, a widget may be available for a media player application. A caregiver may send music or video data to one or more care-receivers. Said music or video data will be sent to the care-receivers' user interface on the family-oriented networking platform.

In one embodiment, a widget may be used with an Instant Messenger. A caregiver may type a message in an Instant Messenger and send this message to one or more care-receivers, wherein the one or more care-receivers are selected from a list of users in the widget. The message will be converted by the widget such that it appears in the care-receiver's user interface on the family-oriented networking platform. The care-receiver may send a message back to the caregiver, and said message will be translated by the widget to show up in the Instant Messenger of the caregiver.

In one embodiment, a caregiver may send information to a care-receiver. Such information may include reminders and/or calendar events. When reminders or calendar events are sent to a care-receiver, these will show up in the care-receiver's calendar on the family-oriented networking platform, or may be converted to an email and appear in the care-receiver's email inbox on the family-oriented networking platform, or a combination of both.

In one embodiment, the reminders or calendar events may be sent to a handheld device to inform the care-receiver of any medication to take or of any appointments while the care-receiver is away from the computer. Reminders and calendar events can also be sent to the handheld device as text to speech, whereby the care-receiver hears the reminders and calendar events as voice messages. The care-receiver can confirm receipt of reminders or calendar events, and a confirmation will then be sent to the family-oriented networking platform.

In one embodiment, a caregiver may review the receipt status of information that was sent to the care-receiver. When a care-receiver confirms receipt of the information that was sent by the caregiver, the receipt status of that information will be updated on the family-oriented networking platform. The receipt status can then also be sent to another application through a widget. Any authorized caregiver, who does not necessarily need to be the caregiver that sent the information, can find out whether the care-receiver has confirmed receipt of the information. The authorized individual may either use the family-oriented networking platform or his/her preferred communication platform by using the widget, to access the receipt status.

The handheld device may further include sensors that measure health parameters to assess whether the care-receiver may need help. These health parameters may include pulse, heat, motion or any combination thereof. When these parameters show that the care-receiver requires help, the handheld device may alert one or more individuals or services by sending a signal to the one or more individuals or services. Said one or more individuals or services may include relatives that the care-receiver has elected to be alerted in case of emergency, or may include emergency services, or a combination of both. Said signal may include information relating to the location of the care-receiver, if the handheld device includes a sensor that permits spatial localization of said handheld device. The handheld device can also be used to provide directions to a predetermined address. These directions may also be converted from text to speech and provided to the care-receiver as a voice message.

The handheld device may be a wristwatch, a mobile phone, a smart phone, a PDA, or any device with mobile communication capability.

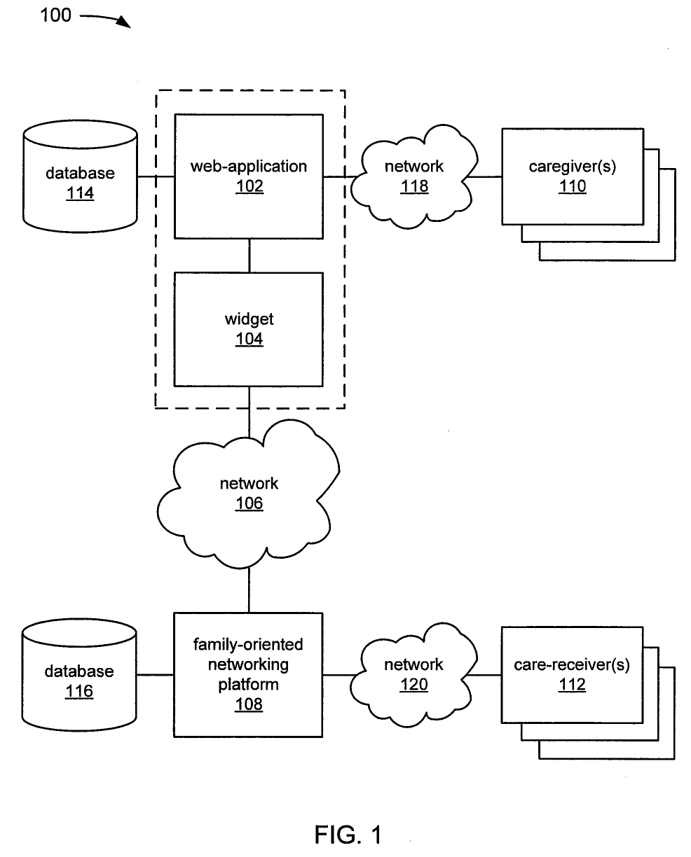

FIG. 1 depicts a diagram 100 of an example of a method of a widget to integrate a web-application with a family-oriented networking platform. FIG. 1 includes web-application 102, widget 104 installed on the web-application 102, network 106, network 118, network 120, family-oriented networking platform 108, caregiver(s) 106, care-receiver(s) 112, database 114 of the web-application 102, and database 116 of the family-oriented networking platform 108.

In the example of FIG. 1, web-application 102 may be a website or application used to communicate with others, a digital media player, a digital photo organizer, or any other application capable of accessing the internet.

In the example of FIG. 1, widget 104 may be installed on the web-application 102 to provide further functionality to the users of the web-application 102, wherein said users may be caregiver(s) 110.

In the example of FIG. 1, network 106 which connects widget 104 and family-oriented networking platform 108, network 118 which connects caregiver(s) 110 and web-application 102, and network 120 which connects care-receiver(s) 112 and family-oriented networking platform 108, can be, but are not limited to, a local area network (LAN), wide area network (WAN), a metropolitan area network (MAN), global area network such as the internet, a Fiber Channel fabric, or any combination of such interconnects.

Care-receiver(s) 112 are users of family-oriented networking platform 108, and may use it for any of the following: receiving and sending emails, viewing and editing a calendar that may include appointments and important dates, getting reminders, viewing photos, and viewing videos, or any combination thereof.

Caregiver 110 may use the widget 104 on web-application 102 to send data to the user interface (not shown) of care-receiver(s) 112 on the family-oriented networking platform 108. Data may include images such as still photography, multimedia such as videos and music, textual data, calendar information, or any other data that may be presented in visual or auditory form to the care-receiver. If the data are stored on a database 114, widget 104 may locate the data and that database 114 and send it to the family-oriented networking platform 108, where it may be stored in database 116.

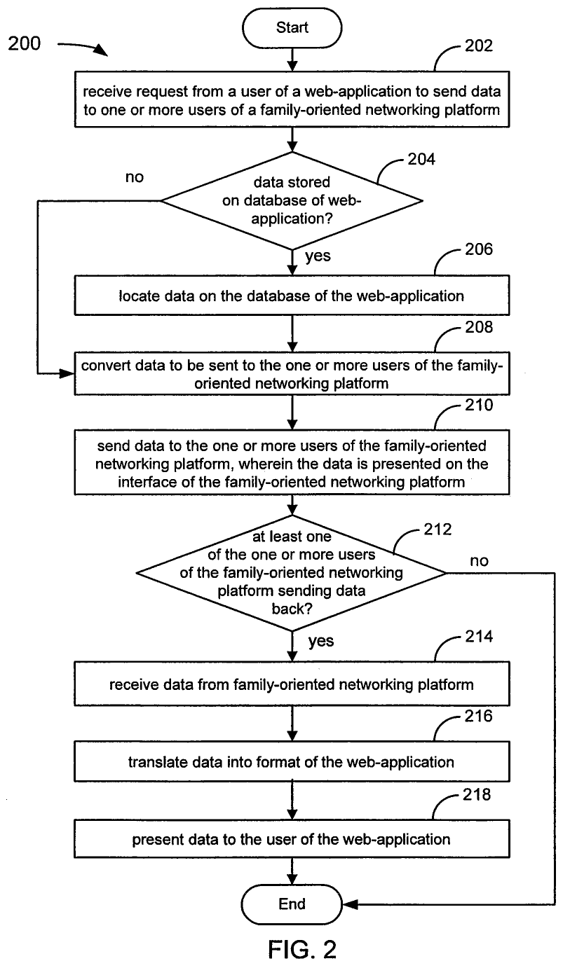

FIG. 2 depicts an example of a flowchart of a method for a web-application to communicate with a family-oriented networking platform.

In the example of FIG. 2, the flowchart starts at module 202 with receiving a request from a user of a web-application to send data to one or more users of a family-oriented networking platform.

In the example of FIG. 2, the flowchart continues with module 204 with determining whether data is stored on a database of the web-application.

If the decision at module 204 is yes, then the flowchart continues with module 206 with locating said data on the database of the web-application. The flowchart then continues to module 208 with converting the data to be sent to the one or more users of the family-oriented networking platform. Said data will be converted into a format that the family-oriented networking platform can understand.

If the decision at module 204 is no, then the flowchart continues with module 208 with converting the data to be sent to the one or more users of the family-oriented networking platform.

In the example of FIG. 2, the flowchart continues with module 210 with sending data to the one or more users of the family-oriented networking platform, wherein the data is presented on the user interface of the family-oriented networking platform. In a non-limiting example, data may be presented as an email in the inbox of the family-oriented networking platform. Data may also be presented in another form that allows the care-receiver to easily access and view it.

In the example of FIG. 2, the flowchart continues with module 212 with determining whether at least one of the one or more users of the family-oriented networking platform is sending data to the web-application. The family-oriented networking platform may provide a way for the care-receivers to send data back to the caregivers on the web-application.

If the decision at module 212 is yes, then the flowchart continues to module 214 with receiving data from the family-oriented networking platform. This data is then translated by the widget at module 216 into a format that can be represented by the web-application. The data is then presented to the user of the web-application at module 218. Having presented the data, the flowchart terminates. If the decision at module 212 is no, the flowchart terminates.

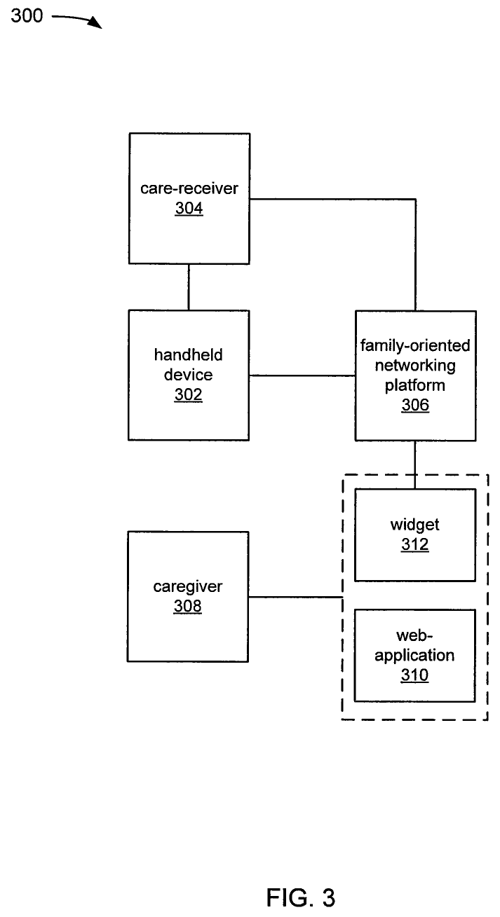

FIG. 3 depicts a diagram 300 of an example of a method for facilitating interactions between a caregiver and a care-receiver.

In the example of FIG. 3, A caregiver 308 may exchange information with family-oriented networking platform 306 through widget 312 on web-application 310. Said information may be synchronized with personal data about care-receiver 304, said personal data being stored on handheld device 302. Said handheld device 306 allows care-receiver 304 to view said personal data, wherein said personal data may include contact information, or information about the health of care-receiver 304, or both.

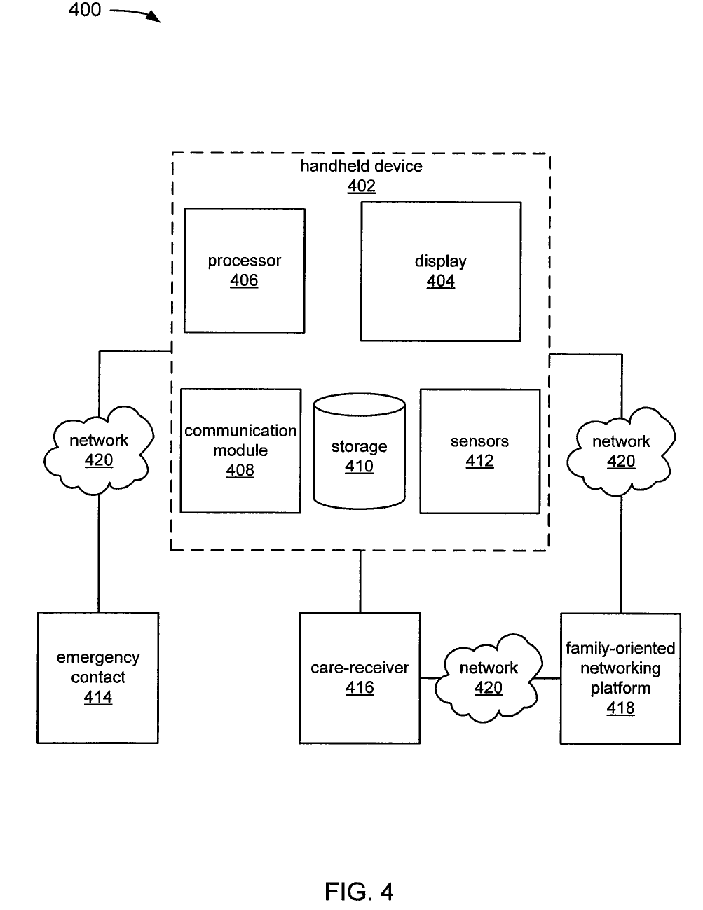

FIG. 4 depicts a diagram 400 of an example of a handheld device to monitor health parameters of a care-receiver and alert a predetermined recipient in case of emergency.

In the example of FIG. 4, handheld device 402 includes display 404, processor 406, communication module 408, storage 410 and sensors 412.

In the example of FIG. 4, storage 410 may be any computer readable storage medium, such as, but not limited to, read-only memories (ROMs), random access memories (RAMs), EPROMs, EEPROMs, flash memory, magnetic or optical cards, or any type of media suitable for storing electronic instructions. Storage 410 may include health information about care-receiver 416, such as allergies, conditions, medications taken, or medical history. Storage 410 may also include contact information, such as contact information of emergency staff, doctors, or relatives.

In the example of FIG. 4, sensors 412 may include, but are not limited to, any or a combination of the following: heat sensor, motion sensor, pulse sensor, proximity sensor, and contact sensor. A heat sensor may measure the heat output of a person wearing said handheld device. A motion sensor measures the motion of the handheld device. A pulse sensor may be used to measure the pulse of a person wearing handheld device 402. Handheld device 402 may be programmed to measure parameters relating to the health, only when said handheld device 402 is worn by a person, such as care-receiver 416. To determine whether the device is worn by a person, handheld device 402 may include sensors 412 such as proximity sensors or contact sensors. For example, handheld device 402 may only measure heat output when said handheld device 402 is in contact with the skin of a person.

In the example of FIG. 4, communication module 408 may be any means for allowing communication between handheld device 402 and emergency contact 414, and between handheld device 402 and family-oriented networking platform 418. Handheld device 402 can be connected to family-oriented networking platform 418 wirelessly or through a hardwired connection.

In the example of FIG. 4, network 420 connects care-receivers 416 and family-oriented networking platform 418, care-receiver(s) 416 and handheld device 402, and family-oriented networking platform 418 and handheld device 402. Network 420 can be, but is not limited to, a local area network (LAN), wide area network (WAN), a metropolitan area network (MAN), global area network such as the internet, a Fiber Channel fabric, or any combination of such interconnects.

In the example of FIG. 4, handheld device 402 may be used to monitor health related parameters about care-receiver 416, using sensors 412. Care-receiver 416 may view health information, calendar events, or contact information stored on storage 410, on display 404. Processor 406 can be used to determine whether the health parameters measured by sensors 412 indicate that care-receiver 416 requires help. If help is required, communication module 408 sends a signal indicating an emergency to emergency contact 414 through network 420. This signal may include health information about care-receiver 416, and may further include a record of the health parameters measured. If sensors 412 include a sensor capable of determining the physical position of handheld device 402, the signal sent by the communication module 408 may include information about the physical location of handheld device 402, and hence of care-receiver 416.

Care-receiver 416 may change or add health related information, contact information, or calendar events stored on family-oriented networking platform 418 through network 420. Information about care-receiver 416 stored on family-oriented networking platform 418, may also be changed by other authorized individuals. Family-oriented networking platform 418 may synchronize information about care-receiver 416 with handheld device 402 through network 420.

In the example of FIG. 4, sensors 412 may continuously measure health related parameters of care-receiver 416, or measure these parameters at given intervals, preferable at least every few minutes. Processor 406 may analyze and send these health related parameters to be stored on storage 410. Health related parameters may be stored on storage 410 for a given timeframe. This allows emergency services or other anyone reading storage 410 to see the evolution of the health related parameters in the given timeframe before the emergency occurred.

In one embodiment, storage 410 may be removable from handheld device 402. For example, storage 410 may be in the form of a USB stick that attaches to a specific location on handheld device 402. Alternatively, storage 410 may be a non-volatile flash memory card, or any other form of portable data storage device.

In one embodiment, storage 410 may be removable and information stored on storage 410 may include allergies, conditions, medications taken, or medical history, and may be viewed by emergency services.

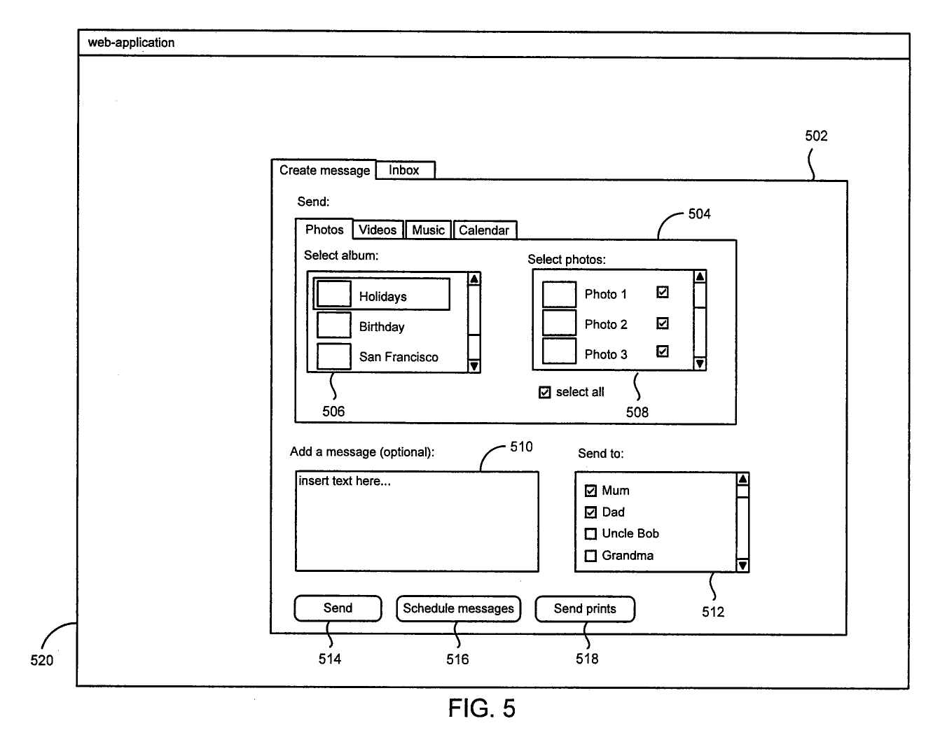

FIG. 5 depicts a diagram 500 of an example screenshot of a user interface of a widget, according to one embodiment

In the example of FIG. 5, widget 502 may be installed on web-application 520 to allow a caregiver to interact with one or more care-receivers on a family-oriented networking platform. Web-application 520 may be the preferred means of digital communication for the caregiver, whereas the one or more care-receivers preferably use a family-oriented networking platform. Widget 502 provides a selectable interface 504, where the caregiver may choose the type of data to send to one or more care-receivers. Said data may be in the form of photos, videos, music, or calendar events, or any combination thereof. In a non-limiting example, the caregiver may choose to send photos from the web-application to the family-oriented networking platform. The caregiver may have a multitude of albums stored on the web-application 520. A list of available albums may, for example, be shown in a scrollable window 506. When the caregiver selects one or more albums from the list, the photos contained in said one or more albums will appear in a scrollable window 508. The caregiver may then choose which photos to send to one or more care-receivers by checking the appropriate checkbox next to the chosen photos. The caregiver may optionally add text in an input window 510, which will be sent along with the photos and appear on the care-receiver's interface on the family-oriented networking platform. Alternatively or in addition to the previous embodiment, the caregiver may choose to add text to any photos individually. The caregiver can select the recipients of the data by selecting them in a scrollable window 512 from a list of recipients. Upon completion of the aforementioned steps, the caregiver may send the data by clicking a send button 514.

In one embodiment, the caregiver may choose to schedule messages by clicking button 515. In a non-limiting example, this would allow the caregiver to choose photos to be sent to the care-receiver at predetermined intervals. The caregiver may choose to send one or more different photos to the care-receiver, for example on a daily, weekly, or monthly basis, and choose the time that photos will be sent. Alternatively, the caregiver can also make the widget to automatically send photos of a newly created album to the care-receiver on the family-oriented networking platform, once said album is created.

In one embodiment, the caregiver may click button 518 to send photos in print to one or more care-receivers. The caregiver may also sign up for a service that automatically sends prints of a given data. This data may include, but is not limited to, photos, calendar, and medication overview.

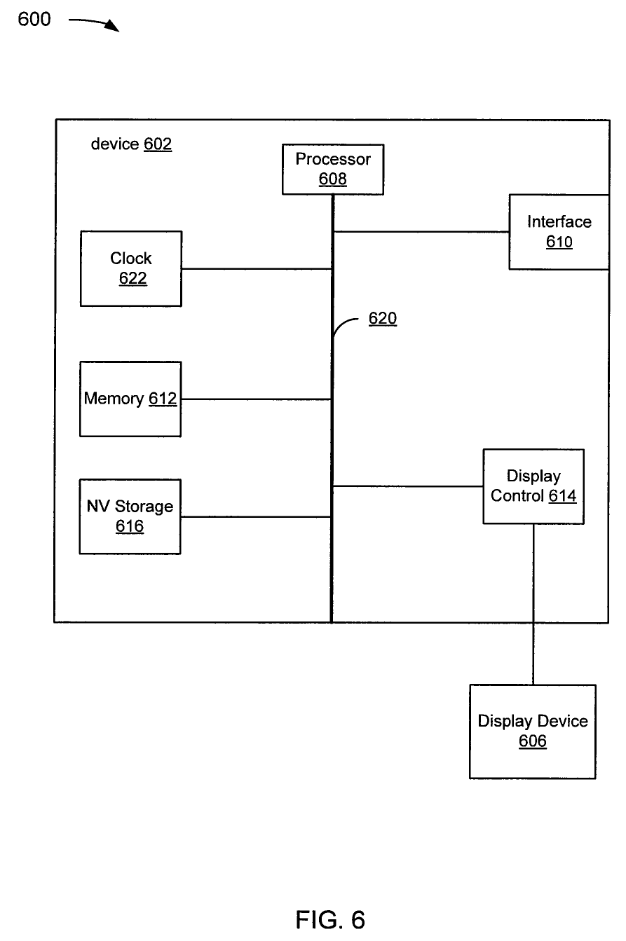

FIG. 6 depicts an example of a system 600 for integrating a web-application with a family-oriented networking platform through a widget. The system 600 may be a conventional computer system that can be used as a client computer system, such as a wireless client or a workstation, or a server computer system. The system 600 includes a device 602, and a display device 606. The device 602 includes a processor 608, a communications interface 610, memory 612, display controller 614, non-volatile storage 616, clock 622. The device 602 may be coupled to or include the display device 606.

The device 602 interfaces to external systems through the communications interface 610, which may include a modem or network interface. It will be appreciated that the communications interface 610 can be considered to be part of the system 600 or a part of the device 602. The communications interface 610 can be an analog modem, ISDN modem or terminal adapter, cable modem, token ring IEEE 802.5 interface, Ethernet/IEEE 802.3 interface, wireless 802.11 interface, satellite transmission interface (e.g. “direct PC”), WiMAX/IEEE 802.16 interface, Bluetooth interface, cellular/mobile phone interface, third generation (3G) mobile phone interface, code division multiple access (CDMA) interface, Evolution-Data Optimized (EVDO) interface, general packet radio service (GPRS) interface, Enhanced GPRS (EDGE/EGPRS), High-Speed Downlink Packet Access (HSPDA) interface, or other interfaces for coupling a computer system to other computer systems.

The processor 608 may be, for example, a conventional microprocessor such as an Intel Pentium microprocessor or Motorola power PC microprocessor. The memory 612 is coupled to the processor 608 by a bus 620. The memory 612 can be Dynamic Random Access Memory (DRAM) and can also include Static RAM (SRAM). The bus 620 couples the processor 608 to the memory 612, also to the non-volatile storage 616, and to the display controller 614.

The display controller 614 may control in the conventional manner a display on the display device 606, which can be, for example, a cathode ray tube (CRT) or liquid crystal display (LCD). The display controller 614 can be implemented with conventional well known technology.

The non-volatile storage 616 is often a magnetic hard disk, flash memory, an optical disk, or another form of storage for large amounts of data. Some of this data is often written, by a direct memory access process, into memory 612 during execution of software in the device 602. One of skill in the art will immediately recognize that the terms “machine-readable medium” or “computer-readable medium” includes any type of storage device that is accessible by the processor 608.

Clock 622 can be any kind of oscillating circuit creating an electrical signal with a precise frequency. In a non-limiting example, clock 622 could be a crystal oscillator using the mechanical resonance of vibrating crystal to generate the electrical signal.

The system 600 is one example of many possible computer systems which have different architectures. For example, personal computers based on an Intel microprocessor often have multiple buses, one of which can be an I/O bus for the peripherals and one that directly connects the processor 608 and the memory 612 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 612 for execution by the processor 608. A Web TV system, which is known in the art, is also considered to be a computer system, but it may lack some of the features shown in FIG. 6, such as certain input or output devices. A typical computer system will usually include at least a processor, memory, and a bus coupling the memory to the processor.

In addition, the system 600 is controlled by operating system software which includes a file management system, such as a disk operating system, which is part of the operating system software. One example of operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 616 and causes the processor 908 to execute the various acts required by the operating system to input and output data and to store data in memory, including storing files on the non-volatile storage 616.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is Appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present example also relates to apparatus for performing the operations herein. This Apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, flash memory, magnetic or optical cards, any type of disk including floppy disks, optical disks, CD-ROMs, and magnetic-optical disks, or any type of media suitable for storing electronic instructions, and each coupled to a computer system bus.

The algorithms and displays presented herein are not inherently related to any particular computer or other Apparatus. Various general purpose systems may be used with programs in accordance with the teachings herein, or it may prove convenient to construct more specialized Apparatus to perform the required method steps. The required structure for a variety of these systems will appear from the description below. In addition, the present example is not described with reference to any particular programming language, and various examples may thus be implemented using a variety of programming languages.

What is claimed is:

1. A method for facilitating interactions between one or more caregivers and one or more care-receivers by providing a widget to allow the one or more caregivers to use a web-application to interact with the one or more care-receivers, said care-receivers using a family-oriented networking platform, whereby said web-application and said family-oriented networking platform are the preferred means of digital communication of said caregivers and said care-receivers respectively, the method comprising:
providing a widget on a web-application to communicate with a family-oriented networking platform, wherein one or more caregivers are users of said web-application and one or more care-receivers are users of said family-oriented networking platform; and
providing the one or more caregivers on said web-application access to said widget, wherein said widget is an interface between said one or more caregivers and said one or more care-receivers;
wherein data may be exchanged between the web-application and the family-oriented networking platform through said widget.

2. The method of claim 1, wherein said data includes any combination of the following: images, videos, music, textual data, calendar information.

3. A system comprising:
means for providing a widget on a web-application to communicate with a family-oriented networking platform; and
means for providing one or more caregivers access to said widget, wherein said widget is an interface between one or more caregivers on the web-application and one or more care-receivers on the family-oriented networking platform;
wherein data may be exchanged between the web-application and the family-oriented networking platform through said widget.

4. A method for providing a widget to integrate a web-application with a family oriented networking platform, the method comprising:
providing an installer for a user of the web-application to install the widget on the web-application;
requesting registration of the widget with the family-oriented networking platform; and
providing one or more user bases to connect two or more users of the one or more user bases.

5. The method of claim 4, wherein said registration of the widget with the family-oriented networking platform requires a first name and a last name of a user of the web-application.

6. The method of claim 4, wherein one or more user bases include one or more caregivers.

7. The method of claim 6, wherein an email address of said one or more caregivers is collected.

8. The method of claim 4, wherein one or more user bases include one or more care-receivers.

9. The method of claim 8, wherein an email address of said one or more care-receivers is collected.

10. The method of claim 8, wherein acknowledgement by the care-receiver is required prior to said care-receiver being added to the one or more user bases.

11. A method for facilitating interactions between caregivers and care-receivers by providing a widget on a web-application of a widget to translate data from a web-application to a family-oriented networking platform, the method comprising:
receiving requests from a caregiver for sharing data with a care-receiver, wherein said caregiver is a user of the web-application;
locating said data on a server of the web-application; and
sending said data to the family-oriented networking platform in a format that can be presented on a user interface of said family-oriented networking platform.

12. The method of claim 11, wherein said data is translated into an email and sent to the inbox of the care-receiver on the family-oriented networking platform.

13. The method of claim 11, wherein said data includes one or more from the list of: photo, video, music, text, instant message, calendar event.

14. A machine-readable medium embodying instructions, the instructions, which when executed, causing a machine to perform a method comprising:
receiving requests from a caregiver for sharing data with a care-receiver, wherein said caregiver is a user of the web-application;
locating said data on a server of the web-application; and
sending said data to the family-oriented networking platform in a format that can be presented on a user interface of said family-oriented networking platform.

15. A method for using a widget on a web-application to communicate with a family-oriented networking platform, the method comprising:
logging into the widget;
selecting a care-receiver;
selecting data for sending to said care-receiver;
sending said data to the care-receiver, wherein said data will appear on said care-receiver's user interface on the family-oriented networking platform.

16. The method of claim 15 further comprising adding contact information of the care-receiver.

17. The method of claim 16, wherein the contact information includes one or more email addresses.

18. The method of claim 15 further comprising scheduling of the data delivery to the care-receiver.

19. A method for integrating a care-receiver with a caregiver, comprising:
providing a handheld device, said handheld device containing personal data about a care-receiver, said care-receiver being the user of said handheld device;
synchronizing said personal data with a family-oriented networking platform;
providing a widget for a caregiver to exchange information with a family-oriented networking platform; and
wherein said personal data includes said information.

20. The method of claim 19, wherein said personal data includes at least one of: health information, reminders, calendar events, contact information.

21. A method for a care-receiver to stay up to date with information contained on a family-oriented networking platform, the method comprising:
providing a handheld device;
receiving said information on said handheld device by synchronizing said handheld device with the family-oriented networking platform;
displaying said information on a display of said handheld device.

22. The method of claim 21, wherein said information is presented to the care-receiver as a voice message.

23. The method of claim 22, wherein said information includes at least one of: health information, reminders, calendar events, contact information.

24. The method of claim 21, further comprising providing means for confirming that said information has been received.

25. The method of claim 24 further comprising sending a confirmation when said care-receiver uses said means for confirming that said information has been received, wherein said confirmation will be synchronized with said family-oriented networking platform.

26. A handheld device to monitor health parameters of a care-receiver and alert a predetermined recipient in case of emergency, the handheld device comprising:
a processor;
one or more sensors monitoring one or more health parameters of the care-receiver;
a communication module, wherein said communication module sends an alert to the predetermined recipient when at least one of said one or more health parameters indicate an emergency;
a location device, wherein said location device can determine a physical location of said handheld device;
a storage device;
a display screen; and
an attachment means to attach said handheld device to said care-receiver.

27. The handheld device of claim 26, wherein the one or more sensors measure any of: pulse, heat, motion, or any combination thereof.

28. The handheld device of claim 26, wherein said predetermined recipient is an emergency service.

29. The handheld device of claim 26, wherein the location device is a GPS sensor.

30. The handheld device of claim 26, wherein the location device uses triangulation of wireless signals to determine the physical location of said handheld device.

31. The handheld device of claim 30, wherein said wireless signals are mobile phone signals from at least three mobile phone cells.

32. The handheld device of claim 26, wherein said storage device contains calendar information.

33. The handheld device of claim 32, wherein said calendar information is synchronized with a family-oriented networking platform through said communication module.

34. The handheld device of claim 32, wherein said calendar information is presented on the display screen.

35. The handheld device of claim 34, further including a loudspeaker, wherein said processor converts said calendar information into sound, wherein said sound is outputted by said loudspeaker.

36. The handheld device of claim 32, wherein said storage device further contains health information of said care-receiver.

37. The handheld device of claim 36, wherein said storage device is removable.

38. The handheld device of claim 37, wherein said storage device further contains contact information.

39. The handheld device of claim 37, wherein said storage device contains a record of the health parameters measured by the sensors up to a given time.

40. The handheld device of claim 26, wherein said handheld device is a wristwatch.
